(19) United States
(12) Patent Application Publication
(10) Pub. No.: US 2007/0016344 A1
(43) Pub. Date: Jan. 18, 2007

(54) Systems and methods for voice communications and control using adapted portable data storage and display devices

(75) Inventor: Rolf Stefani, West River, MD (US)

Correspondence Address: OLIFF & BERRIDGE, PLC, P.O. BOX 19928, ALEXANDRIA, VA, 22320, US

(73) Assignee: ARINC, INCORPORATED, Annapolis, MD (US)

(21) Appl. No.: 11/181,991

(22) Filed: Jul. 15, 2005

(51) Int. Cl. G06F 17/00

(52) U.S. Cl. 701/3

(57) ABSTRACT

A software application hosted on portable electronic digital data storage and display devices, such as Class 1 or 2 certified EFB computing devices in the cockpits of aircraft, integrates system components to allow users to initiate voice communications with various receiving destinations via a WiFi or other communications network. The portable electronic data storage and display device may be configured with a microphone and speakers to facilitate voice transmission and reception via a communications link established between the device and a destination computer, or alternatively a PSTN device to facilitate voice transmission via an accessible “direct dial” telephone system.

### BACKGROUND

This disclosure is directed to systems and methods for implementing an integrated voice communications and control interface executed through a portable data storage and display device. The systems and methods are particularly useful for integrating and coordinating all non-air-traffic-control communication from an aircraft on the ground via an Electronic Flight Bag (EFB).

U.S. patent applications Ser. Nos. 10/919,318 and 10/971,104, by the same inventor and commonly assigned, are incorporated herein in their entirety by reference. These applications teach the use of portable data storage and display devices to streamline, make more efficient, and/or make safer, operations that require relatively immediate access to a particular individual data reference page contained in the volumes of stored data reference pages, which could number in the tens of thousands of such individual pages, particularly in high task-loading environments. The above-described applications are directed to, for example, Electronic Flight Bags (EFBs), that are carried in the cockpits of aircraft. EFBs can be advantageously employed to provide an integrated, user-friendly, interactive platform to coordinate many routine tasks requiring access to data for time critical data recall and manipulation, and/or for crew coordination.

The above referenced applications explain that the introduction of EFBs into the cockpits of aircraft provides an automated and interactive library of publications in electronic format to replace the conventional flight bag full of checklists, charts, publications and the like. Specific reference pages as may be required for preflight, start, taxi, takeoff, departure, inflight/enroute navigation, arrival, approach, landing, taxi, shutdown and postflight are readily available. For flight operations in the United States alone, a total page count for all of the required documents could number in the tens of thousands. These pages include: individual airport diagrams; airport runway approach and/or departure procedures; various enroute navigation specific charts; normal, special and/or emergency procedures checklists and publications; aircraft operating manuals including tables of operating limitations; and/or other pertinent or required information publications. The EFB can be commanded to display information that supports safe and efficient conduct of a flight from preflight through postflight including, for example, information regarding a departure airport (including the airport diagram), departure procedures from that airport, enroute flight information, approach procedures at a destination airport, and information regarding the destination airport (including the airport diagram). Interspersed between static “information only” data reference pages, as a flight crew member may individually desire, may be required checklists such as, for example, preflight, start, ground/taxi/takeoff, departure, enroute, arrival/descent, terminal area, landing, post landing and shutdown checklists, any or all of which may be displayed in an interactive manner. With such a capability, a flight crew member can select a static page of data to be displayed. Alternatively, the flight crew member can initiate interactive routines for, for example, executing checklists or filling out forms or the like, by selecting a dynamically interactive data reference page in which steps in a checklist, or blanks in a form, may be provided. These blanks can then be completed by the flight crew member, the EFB displaying an indication of completion, and optionally storing a record of such completion. All of the varying combinations of available features are intended to reduce crew workload and to promote safe, simple, and effective interaction among crew members and with outside resources thereby enhancing safe and effective aircraft operations.

The capabilities of such portable data storage and display devices are limited only by: (1) internal data storage capacities; (2) specific functionalities assigned to individual pages which can display data in a textual or graphical format, or specific functionalities that otherwise provide a user with a capability to interact with the device and the data stored therein; and/or (3) methodologies or capabilities for manipulating pages of data resident in the device or for coordinating actions external to the device via any manner of internal and/or connectable automated or manual input/output interface.

### SUMMARY

Many new communications technologies have emerged in the last several decades. Most often, each of these communications technologies includes its own proprietary, task-specific, or single-use communications link to provide access to the technology and to others connected to the communications link. Associated with each such communications link is generally a related communicating device by which a user can access the technology, and only the technology, implemented by that specific communications link. Individual users attempting to make use of myriad communications technologies capabilities have had to, therefore, employ a number of different devices in order to communicate effectively over multiple available lines of communication. The difficulties in using multiple single-line-of-communication devices to communicate with myriad receiving nodes are particularly acute in high task-loading environments such as, for example, the cockpits of modern commercial aircraft.

As an example of the above-described problem, when an aircraft is on the ground, voice communication to many and widely varied receiving nodes typically must be performed. Air traffic control communications are usually undertaken with conventional VHF and/or UHF radio systems installed in the aircraft. Cockpit flight crew members must separately, however, communicate with multiple receiving nodes quickly and routinely to, for example coordinate operations and any changes to schedules, and/or exchange routine and abnormal aircraft status and operating information. These receiving nodes include, but are not limited to: dispatchers at remote locations; ground handling personnel in the vicinity of the aircraft; aircraft maintenance personnel located remotely on the airfield; and myriad ground services organizations or providers such as providers of catering, baggage handling, fueling, gate and terminal access and airport security. These communications are traditionally undertaken via hard-wired connections, such as individual intercom systems, separate discrete radio frequencies, or simply by passing notes, e.g., handwritten notes on paper.

Typically, an individual flight crew member must decide with whom he or she needs to, or wishes to, communicate. Separately, the individual flight crew member must decide which communications line should be chosen to facilitate that communication. The selected communications line must be opened. Only then can the transmission of information, either as voice or data, be undertaken. The time-consuming nature of this process, particularly as it may impede the transmission of time-critical information, or impact safe and efficient operations, makes this process ripe for being made more efficient through the application of an integrating and/or streamlining communicating technology.

A recognition of the above-described difficulty led the telecommunications industry to attempt to consolidate the ability to communicate over multiple lines of communication for data and/or voice transmission and reception into a family of individual multi-functional communicating devices. Each of these multi-functional communicating devices may however, have certain disadvantages. One disadvantage is that these devices are difficult to adapt to certain high-task loading environments. An alternative solution is sought in expanding the capability of a single line of communication to reach all receiving nodes and providing a simple, cost-effective capability to mobilely access such an all-encompassing single line of communication.

It would be advantageous to implement, in a single integrated communicating device, technology to facilitate transmission and reception of voice communications across an all-encompassing communications path through an efficient single-source coordinated communications control node.

Wireless fidelity (WiFi), or wireless Ethernet, network communications on and around airport surfaces are now available. Commercial Voice-over-IP (VoIP) services and applications that provide Internet connectivity between voice nodes are also available. Exemplary systems and methods according to this disclosure may use such networks, services and/or applications to support integrated single-source controlled and executed voice communications. Such voice communications may particularly include, for example, non-air-traffic-control communications from cockpits of aircraft to virtually all compatibly-equipped receiving nodes.

Various exemplary embodiments of disclosed systems and methods may provide a capability to bring together in an integrated system a single coordinated voice communications hub usable by, for example, flight crew members in the cockpits of aircraft for coordinating and controlling at least routine communications when an aircraft is on the ground.

Various exemplary embodiments of disclosed systems and methods may provide software applications to be hosted on Class 1 or 2 certified EFB, or other portable data storage and display, devices in the cockpits of aircraft. These software applications may integrate necessary system components for voice communications and control. Exemplary embodiments may, for example, allow flight crew members to initiate outgoing voice communications to various pre-configured and/or ad hoc ground-based destinations, and/or to receive incoming voice communication from such destinations. One exemplary area for facilitating communication may be, when an aircraft is on the ground, via an available WiFi communications network located on and around an airport. Such an example is, however, merely only illustrative.

Various exemplary embodiments of disclosed systems and methods may incorporate into available state-of-the-art commercial EFBs, or other portable data storage and display devices, an audio input/output interface that provides a capability for a user to provide audio input to, e.g., speak to, and/or receive audio input from, e.g., listen to, the EFB.

Various exemplary embodiments of disclosed systems and methods may provide an EFB, or other portable data storage and display, device configured with a microphone and speakers in order to facilitate voice transmission and reception via a communications link established between the EFB and a destination computer, or alternatively a PSTN device to facilitate voice transmission between the cockpit and myriad receiving nodes via an accessible “direct dial” telephone system. In such an instance, an appropriately-configured destination computer would provide access to the telephone system.

Various exemplary embodiments of disclosed systems and methods may provide software capability stored in an EFB, or other portable data storage and display device, to convert voice communications for transmission over a short range WiFi network, and an integrated network internal, for example, to an aircraft, including an antenna which may be compatible with the WiFi network to facilitate such transmission.

Various exemplary embodiments of disclosed systems and methods may allow an individual user to pre-program a list of receiving nodes, or other communications destinations, that the user may desire to call using an appropriately-configured portable data storage and display device, such as an EFB. This pre-programmed list may subsequently be presented to the user at the user's selection of a specific voice communications and control application resident within the EFB, allowing the user to rapidly recall contact information and execute voice contact with various receiving nodes with, for example, actuation of a single or plurality of user interface controls via a single integrated communications coordinating and control capability resident within the EFB.

Various exemplary embodiments of disclosed systems and methods may provide a user with a simple graphical display to enable a user to initiate transmission and/or reception of voice communications via a voice communications and control application in a portable data storage and display device.

Various exemplary embodiments of disclosed systems and methods may enhance safe and effective communications by voice with myriad task-related facilities, as needed, in real time.

Exemplary embodiments of disclosed systems and methods may be described herein to refer to a specific application of communication between a flight crew member in the cockpit of an aircraft and various non-air-traffic-control communication receiving nodes with which the flight crew member must administratively communicate. Further, the exemplary embodiments may describe a manner in which such communications may be facilitated by employing a portable data storage and display device such as, for example, an EFB, to integrate, coordinate and/or control the communications, particularly through an integrated voice communications and control application stored in, and/or executable through, the device. Such communications may be transmitted and received, for example, across a WiFi network employing VoIP services for voice communication via the Internet. The disclosed systems and methods should, however, not be construed as limited to such an application. Rather, such devices are also usable in other multi-person, or multi-crew member, high-task loading environments requiring rapid access to multiple receiving nodes, or which require an ability to switch in an effective and often time critical manner between such receivers. Simple expansion of the concepts for employing the disclosed systems and methods may include, for example, if FAA certified for use of such a device, include incorporation of typical air traffic control communications, e.g. ground control and or clearance delivery services, when an aircraft is on the ground.

These and other features and advantages are described in, or apparent from, the following detailed description of various exemplary embodiments of disclosed systems and methods.

### BRIEF DESCRIPTION OF THE DRAWINGS

Various exemplary embodiments of disclosed systems and methods will be described, in detail, with reference to the following figures, wherein:

FIG. 1 illustrates an exemplary embodiment of an internal aircraft communications system that includes a cockpit-installed private local area network usable with disclosed systems and methods to facilitate communications with a plurality of portable data storage and display devices, such as EFBs;

FIG. 2 illustrates a block diagram of an exemplary embodiment of a generic portable data storage and display device, of which an EFB is one specific example, usable with the disclosed systems and methods as modified to, for example, facilitate voice communication between an individual user and multiple receiving nodes;

FIG. 3 illustrates a first operating view of an EFB as an example of a portable data storage and display device usable with the systems and methods according to this disclosure;

FIGS. 4A-4D illustrate exemplary embodiments, in greater detail, of receiving node direct access buttons usable as part of an exemplary voice communications and control application in the EFB of FIG. 3;

FIG. 5 illustrates a second operating view of the EFB of FIG. 3; and

FIG. 6 illustrates a third operating view of the EFB of FIG. 3.

### DETAILED DESCRIPTION OF EMBODIMENTS

The following description of various exemplary embodiments will describe systems and methods for integrating at least cockpit flight crew non-air-traffic-control communication over a WiFi network employing commercial VoIP services as part of a voice communications and control application. This voice communications and control application will be described resident in an EFB. The discussion will focus on currently available EFB devices for such integration and coordination. A cockpit-installed private local area network will be described as usable to provide support for at least one EFB device and to provide connection for the device to, for example, an external communications antenna to facilitate employment of an airport-installed WiFi network. However, it should be appreciated that the disclosed principles, as outlined and/or discussed below, are not to be so narrowly construed. The disclosed systems and methods may find equal utility with any portable and/or handheld, electronic, and/or digital data storage and display device which can be adapted with at least an audio input/output capability for facilitating integration and coordination of communications, specifically voice communications via the Internet or otherwise.

The disclosed systems and methods generally leverage currently available capabilities presented by WiFi (wireless fidelity), or wireless Ethernet, networks. These networks typically have a relatively short range and, as such, may only be available in a relatively small local area. Commercially-available software capabilities to implement voice communication, for example, Voice over IP (VoIP) communications via the Internet may also be used. Addition ally, access to a PSTN may be facilitated through an appropriately-configured computer at a receiving node to provide broader communications access. However, disclosed systems and methods are not limited by or to any of the enumerated capabilities.

Various exemplary embodiments of disclosed systems and methods integrate voice communications and control capabilities by, for example, hosting software on a Class 1 or 2 certified EFB, or other portable data storage and display, device for use, for example, in the cockpit of an aircraft. Such an application may expand the capability of the current state-of-the-art EFB suite of products to include an integration capability for all or virtually all non-air-traffic-control communication through a single integrated node in the cockpit.

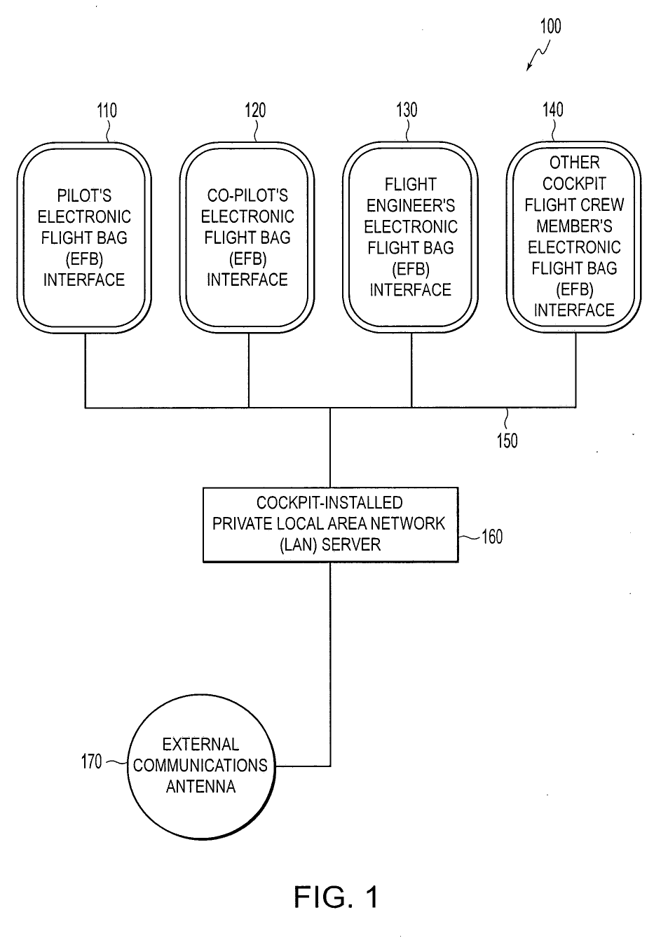

FIG. 1 illustrates an exemplary embodiment of an internal aircraft communications system 100 that includes a cockpit-installed private local area network usable with disclosed systems and methods to facilitate communications with a plurality of portable data storage and display devices, such as EFBs. As shown in FIG. 1, a capability to accommodate disclosed systems and methods may be provided across a voice/data communications backbone that includes multiple interfaces 110-140 to accommodate, and provide an interactive link to, individual cockpit flight crew members' EFBs or other like portable data storage and display devices. These interfaces may be individually connected via an exemplary cockpit-installed private local area network data and control bus 150, as depicted, or by any other data transfer connection means. The data and control bus 150 may be connected to a private local area network server 160, or to an information storage and/or data processing device that may separately implement portions of a voice communications and control system.

In various exemplary embodiments of disclosed systems and methods, the data and control bus 150 may also provide a communications link to other peripheral devices. An external communications antenna 170 such as, for example, an aircraft antenna, which may be conformal to the aircraft structure and may support communications with a WiFi network as well as other external communications, may be connected into the cockpit installed private local area network.

It should be appreciated that, while depicted and discussed as a hard-wired, seemingly permanent, installation, the exemplary data communications connections provided between individual EFB interfaces 110-140, the cockpit-installed private local area network server 160 and the external communications antenna 170 may be any known or later-developed connection that supports data transfer in the form of, for example, VoIP data communications, between portable data storage and display devices and an external communications capability for transmitting data from and receiving data to individual portable data storage and display devices. The data communications connections may include any form of wired, wireless or optical communications connections, or any combination of those, between communicating elements.

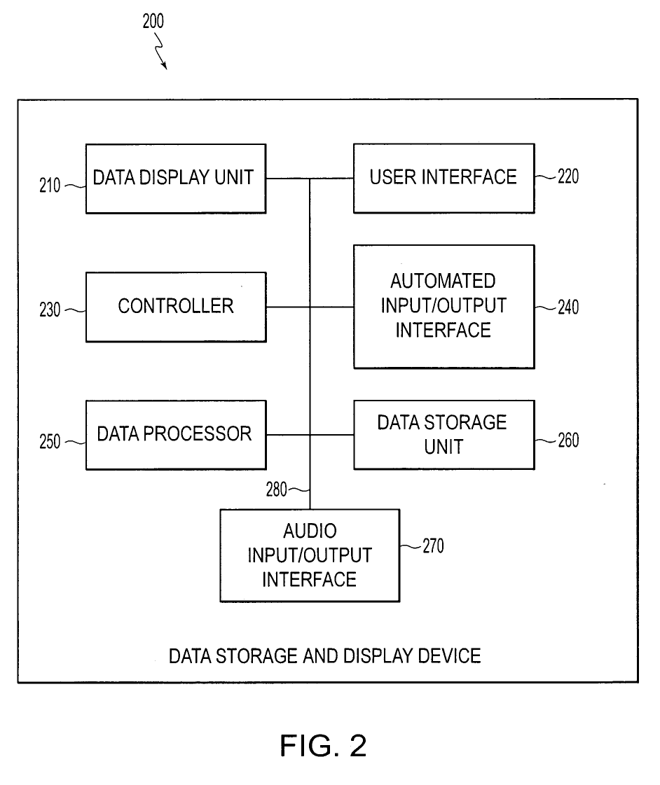

FIG. 2 illustrates a block diagram of an exemplary embodiment of a generic portable data storage and display device 200, of which an EFB is one specific example, usable with the disclosed systems and methods as modified to, for example, facilitate voice communication between an individual user and multiple receiving nodes.

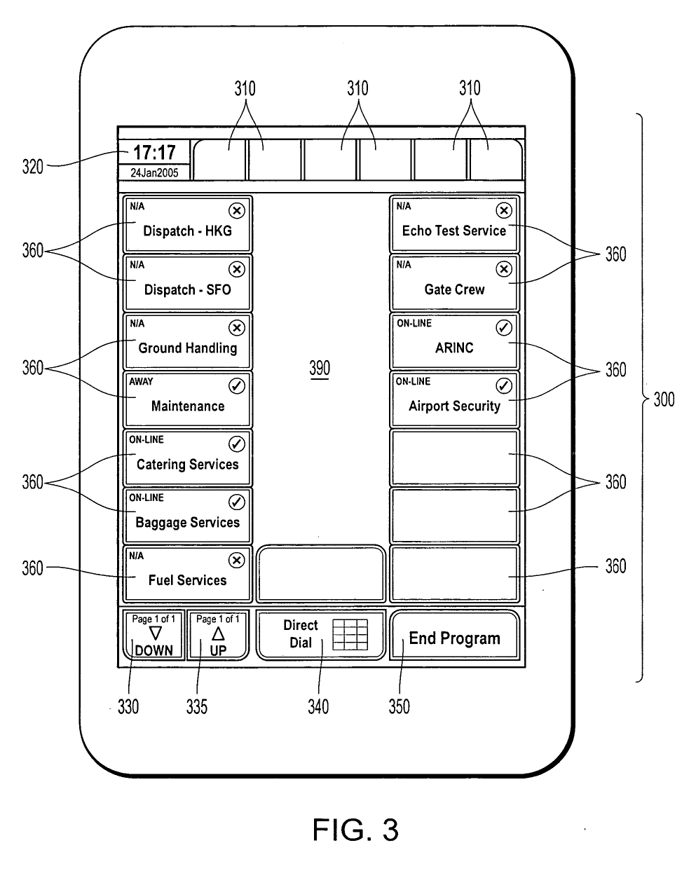

In the following discussion, a generic data storage and display device 200 is described with reference to FIG. 2. Then below, with reference to FIGS. 3-6, the description will return to an exemplary embodiment of an EFB as an example of a portable data storage and display device.

The exemplary portable data storage and display device 200 depicted in FIG. 2 includes a data display unit 210, a user interface 220, a controller 230, an automated input/output interface 240, a data processor 250, at least one data storage unit 260, and an audio input/output interface 270. Each of these components may be interconnected via a data/control bus 280.

Various exemplary embodiments of disclosed systems and methods may employ any manner of speaker and microphone combination wired to, or otherwise communicating with, compatible connections in the audio input/output interface 270. Such speaker and microphone combination may include, for example, an internal or external microphone, at least one internal or external speaker, a compatible connection to provide audio input to (and receive audio input from) an integral headset including earphones and a microphone, such as, for example, a pilot's headset, or any other like devices. Audio data, such as voice communications, are input to the data storage and display device 200 via the audio input/output interface 270.

The data processor 250 may be available to execute voice communications and control by, for example, being loaded with a VoIP software application, and a voice communications and control application according to this disclosure. The data processor 250 may convert the input audio signal received from a microphone via the audio input/output interface 270 of the data storage and display device 200 to a data packet for file transfer network via the automated input/output interface 240 over a digital, in this case wireless, data communications network. Alternatively, an input data packet received from the data communications network via the automated input/output interface 240 of the data storage and display device 200 may be converted in the data processor 250 to output audio signals and transmitted via the audio input/output interface 270 to the speakers. Additionally, based on receipt of data from via the automated input/output interface 240, the automated input/output interface 240 may automatically, via the data processor 250 or other wise, initiate the at least one software application in response to an incoming call.

All operations of the data storage and display device 200 may be controlled via the controller 230, and information may be displayed to the user on the data display unit 210. The processes resident in the data storage and display device 200 can be manipulated via the user interface 220. More detail regarding data display, user interface and audio signal processing will be outlined below.

In various exemplary embodiments of disclosed systems and methods, a voice communications and control application may be initiated by a user of the data storage and display device 200 through manipulation of at least one interactive display available on the data display unit 210 which allows the user to provide input to the system via the user interface 220. Once the voice communications and control application resident in the data storage and display device 200 is commenced, the application may initially execute a routine to ensure that the device is within the range of, and/or otherwise communicating with, a receiving network. This communication may occur by receiving a signal from the network via, for example, an external communications antenna mounted on an aircraft, a Terminal Wireless LAN Unit mounted within an aircraft, or other like device for facilitating data reception and transmission which may be connectable to the data storage and display device 200 by any manner of connection such as that shown in exemplary manner in FIG. 1.

As will be described in detail below, various exemplary embodiments of disclosed systems and methods provide a capability for a user to initiate a call to either a pre-programmed, or pre-stored communications receiving node or, through a direct dial system manipulated by the user interface 220, to any compatible communications receiving node. It is envisioned that, given the combination of a data conversion system usable to convert audio inputs to transmittable data, or received data to audio outputs, and a data transmission and reception network capability by which such data may be transferred, voice communication will be facilitated through the compatible microphone and speaker and/or standard pilot's headset in order that establishing a communication will be as simple as selecting the capability, selecting a destination node, or even simply dialing a telephone number for access to a PSTN, and talking and/or listening to the data storage and display device 200.

Some or all of the information required to support voice communications and control may be resident in a data storage and display device such as, for example, an EFB. Alternatively, the data storage and display device may be usable only as an input/output device to coordinate and control such an application stored in a local or remote server or other like device. Additionally, the information may require routine update. Such update may, for example, be performed via the automated input/output interface 240, shown in FIG. 2.

Any data storage contemplated for the various disclosed exemplary embodiments may be implemented using any appropriate combination of alterable, memory, or fixed memory. The alterable memory, whether volatile or non-volatile, can be implemented using any one or more of static or dynamic RAM, external disk drives with associated disk-type mediums, such as, for example, a writeable or re-writeable optical disk and disk drive, a hard drive, flash memory or any other memory medium and/or device, internal to, or externally connected with, the exemplary individual portable data storage and display device. Similarly, the fixed memory can be implemented using any one or more of ROM, PROM, EPROM, EEPROM, and optical ROM disk, such as a CD-ROM or DVD-ROM disk, which can be implemented using a compatible, connected disk drive, or internal disk drive, or any other memory storage medium and/or device.

It should be appreciated that, while the processing described herein occurs primarily internal to the exemplary portable data storage and display device 200 running an application to execute voice communications and control, optional provision for such processing could occur by providing control inputs to a data storage device resident within, for example, the cockpit-installed private local area network (LAN) server 160 depicted in FIG. 1. Further, it should be appreciated that, given the required inputs, the processing outlined in the disclosed systems and methods can be implemented through software algorithms, hardware or firmware circuits, or any combination of software, hardware and/or firmware control elements, present in the individual portable data storage and display devices, of which EFBs are examples.

FIG. 3 illustrates a first operating view of an EFB as an example of a portable data storage and display device usable with the systems and methods according to this disclosure.

In various exemplary embodiments of disclosed systems and methods, a voice communications and control application may be provided to allow a user to establish, download, manipulate, manage, and select from, a pre-programmed list of communications receiving nodes that the user may need or desire to contact. Further, there may also be provided a capability to manually enter a dial code or other information for other receiving nodes that have not been previously programmed or otherwise configured. In exemplary embodiments, by simply pressing a graphic button on the display unit of the exemplary EFB 300, software resident in the EFB 300 will establish a point-to-point network connection with destination software and/or devices and display, for example, appropriate status indicators to a user as the communication progresses. Exemplary displays are depicted in FIGS. 3-6. The voice communications and control application may provide a user with a highly configurable interface to a communications capability through direct control of graphic icons displayed on the EFB display screen.

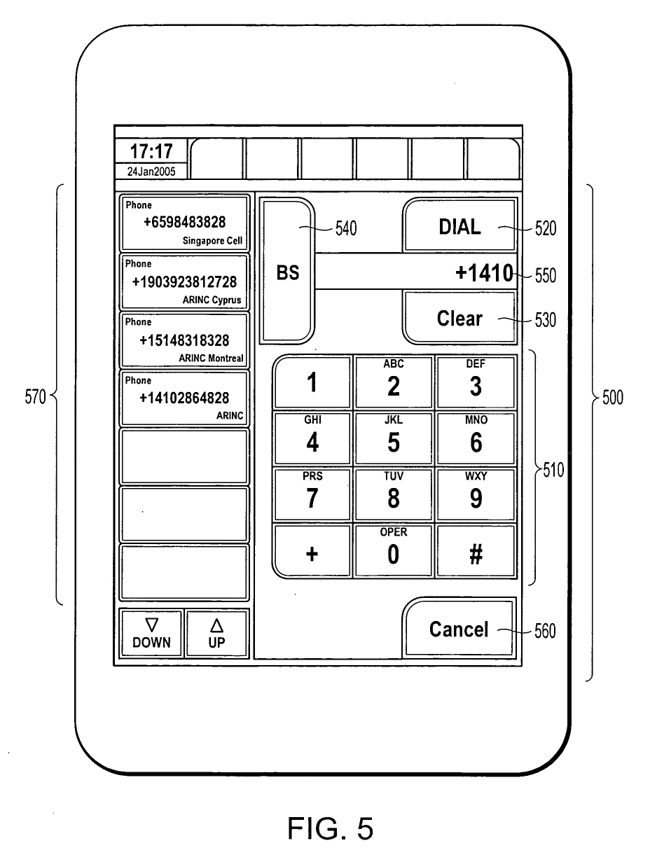

As shown in FIG. 3, a plurality of standard application buttons 310 are provided for selecting applications such as to coordinate and control program management, or various functionalities, within the exemplary EFB 300. A time and date display 320 may also be provided. The EFB 300 may enable scrolling through multiple related pages by manipulating, as appropriate, a down button 330 or an up button 335 to allow sequential review of pages. A capability to end the specific program, in this case the voice communications and control application, is afforded through the manipulation of an end program button 350. An open data field 390 may be provided that displays detailed functionality associated with the voice communications and control application as will be depicted in exemplary manner in later figures. A direct dial mode button 340 may be provided in order to exit the displayed pre-set control or pre-programmed receiving node mode of the voice communications and control application and enter a direct dial mode such as is shown in exemplary manner in FIG. 5, and as will be described in greater detail below.

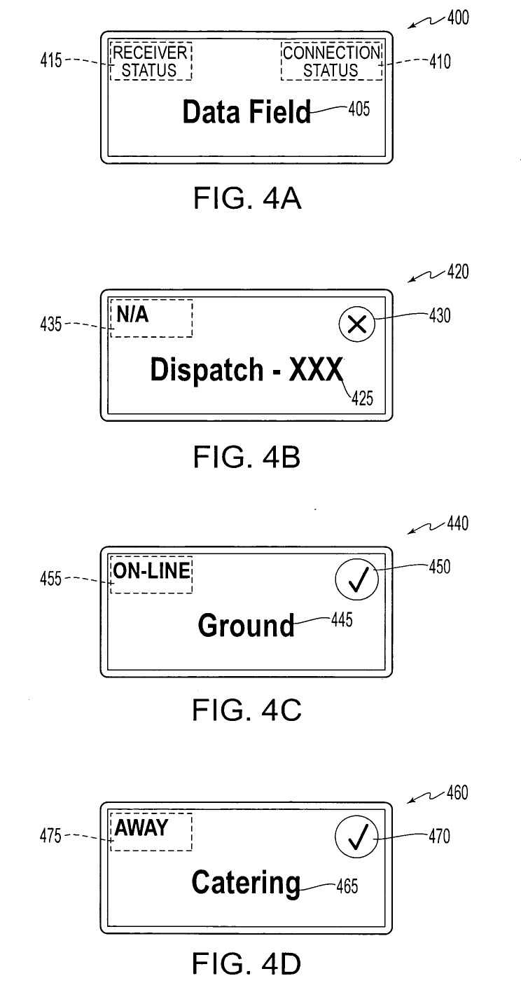

An advantage to the depicted exemplary embodiment of the EFB 300 displaying the graphics related to the voice communications and control application is an ability to have pre-programmed information regarding a plurality of receiving nodes which are available to be standardly communicated with. A plurality of direct access buttons 360 to facilitate immediate access to the pre-programmed direct access receiving nodes are displayed. A user, by pressing any of the configured direct access buttons 360, may cause the software application to attempt to establish voice communication with the pre-programmed receiving node defined on the button. Standard nomenclature may be included as shown in an exemplary manner, in FIG. 3, and in greater detail in FIGS. 4B-4D, for example, dispatch at one or more destinations, ground handling, maintenance, catering, baggage, fuel, Echo test service, gate crew, airport security and/or any other pre-programmed communications receiving node. Different graphic details may be provided on these buttons to indicate status and availability of any of the receiving nodes.

FIGS. 4A-4D illustrate exemplary embodiments, in greater detail, of receiving node direct access buttons 360 usable as part of the exemplary voice communications and control application in the EFB of FIG. 3. Each exemplary embodiment of a direct access button depicted in FIGS. 4A-4D includes like elements. As shown in FIG. 4A, the exemplary direct access button 400 generically includes a data field 405, which, as is detailed in FIGS. 4B-4D, may include nomenclature regarding the receiving node to which that direct access button is allocated such as, for example, dispatch 425 at any destination, ground 445 for generic ground services, or catering 465 for contacting catering and/or kitchen or services. Additionally, each of the exemplary direct access buttons may include, for example, icon symbols on each button to indicate the availability of the selected receiving node. Such a field may, therefore, provide as a data field 410 for connection status for that particular receiving node. Any graphical indication by which a user can readily ascertain status of a connection to a receiving node is contemplated. In the exemplary embodiments shown, an X in a circle 430, may indicate that the receiving node is not connected, and checkmarks in circles 450 and 470 may indicate that the receiving node is connected. Separately, nomenclature regarding receiver status may be displayed in a receiver status data field 415. Such indications may be automatically generated based on status information that is received from, and/or programmable by, the receiving node for display on the exemplary EFB 300 as shown in FIG. 3. Examples may include “N/A” 435 (indicating that connection to this receiving node, is for example, not available), “On-Line” 450 (indicating that a connection could be made to this receiving node), and/or “Away” 475 (indicating, for example, that the receiving node is, in some manner, otherwise occupied or busy), as shown respectively in FIGS. 4B-4D.

It should be appreciated that while the exemplary embodiments of the direct access buttons 400, 420, 440 and 460 are included in order to provide detail regarding possible configurations for the displays thereon, these exemplary embodiments are not limiting regarding what information may be displayed on a direct access button in an exemplary EFB.

FIG. 5 illustrates a second operating view of the EFB 300 of FIG. 3. Should the user desire direct dial access by pressing the direct dial button 340 depicted in FIG. 3, the voice communications and control application display may change to, for example, a direct dial display panel 500, as shown in FIG. 5.

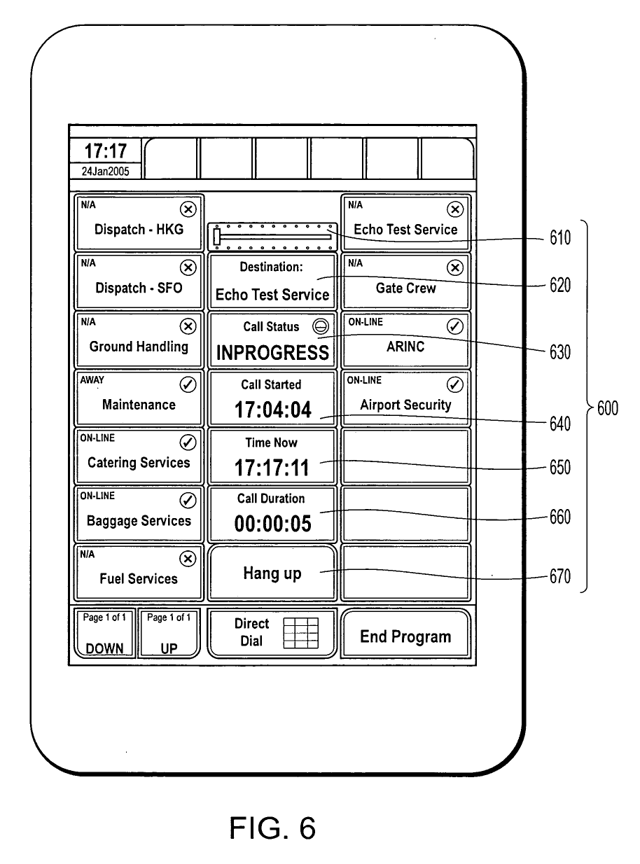

In an exemplary embodiment of the systems and methods according to this disclosure, a user may enter a telephone number, for example, that he or she desires to contact via the telephone-like alpha-numeric keypad 510. The direct dial telephone number to be dialed may then be displayed in a dial number data field 550. Once the user has confirmed that the telephone number that he or she wishes to dial is correct, the user may then initiate a call by pressing a dial command button 520. In order to clear the dial number data field. 550, a clear command button 530 may be provided. In order to correct a single digit or plurality of individual digits incorrectly input, a back space (BS) command button 540 may also be provided. By pressing a cancel button 560, the direct dial mode may be exited and the main display of the voice communications and control application, such as that shown in exemplary manner in either FIG. 3 or FIG. 6 may be displayed. Additionally, a series of buttons 570 may be displayed, representing direct dial telephone numbers that may be dialed by simply pressing one of the series of buttons 570. Alternatively, operating one of the series of buttons 570 may result in a telephone number being displayed in the dial number data field 550, thus requiring a second actuation of either the one of the series of buttons 570, or actuation of the dial command button 520. Additionally, once a dial command is initiated by manipulation of either the dial command button 520 or the one of the series of buttons 570, the direct dial screen may be dismissed and the primary voice communications and control application window displayed.

FIG. 6 illustrates a third operating view of the EFB 300 of FIG. 3. As shown in FIG. 6, when a call is in progress, an exemplary display may include an additional call in progress display field 600. The display field 600 may be interactive and may include a volume adjustment capability 610, a destination confirmation field 620, a call status field 630, a call start time 640, a real-time indication 650 and a call duration timer 660. Call status may be indicated in the call status button 630 by a nomenclature or by some icon to indicate status of the call such as, for example, “in progress,” “ringing,” “finished,” “missed,” “routing” or any other related call status indication. It should be appreciated that certain of the other functionalities displayed on the EFB surrounding the in progress call display 600 may be disabled in order that the call is not accidentally terminated through inadvertent manipulation of some other function button. A hang-up button 670 may be provided in order to manually terminate the call from this device. Other display selections may include, for example, highlighting the direct access button or destination confirmation field 620 to whom the call is placed. Additionally, manipulation of the direct access button to which the call is placed while the call is in progress may result in manually disconnecting that call. Through any of the aforementioned displays, the system may graphically indicate, at any time, a real-time status of a call.

It should be appreciated that, although not specifically depicted, virtually any available voice communications functionality, now known, or as may be contemplated, may be incorporated into the disclosed device. Such functionality may include, for example, conference calling, call waiting, call hold, and/or call forwarding. Further, call lists of pre-stored destinations may be downloadable from, for example, any receiving node or a system administration database.

While exemplary embodiments have been described above, these exemplary embodiments should be viewed as illustrative, and not limiting. Various modifications, substitutes, or the like are possible within the spirit and scope of this disclosure.

What is claimed is:

1. A system for facilitating voice communications and control, comprising:
a portable electronic data storage and display device that includes:
a data storage unit that stores a plurality of interactive data reference pages and at least one software application that converts input audio signals to output data and input data to output audio signals;
a data display unit that displays a user-selected individual data reference page chosen from the plurality of interactive data reference pages and information related to the at least one software application;
a user interface that allows a user to select and to interact with the user-selected individual data reference page and the at least one software application;
a data input/output interface that links the portable electronic data storage and display device to a compatible communications interface to facilitate receiving and transmitting data related to audio signals input to or output from the portable electronic data storage and display device;
an audio input/output interface that facilitates inputting audio signals to and outputting audio signals from the portable electronic data storage and display device; and
a data processor that processes at least one of user inputs received through the user interface, data inputs from the data input/output interface, or audio inputs from the audio interface, and that drives the display unit to display information related to the at least one software application, and
a data communication network interface device that facilitates transmission and reception of data available via the data input/output interface to and from at least one remote receiving node,
wherein the portable electronic data storage and display device is usable to facilitate voice communications via the data communication network interface.

2. The system of claim 1, wherein the portable electronic data storage and display device is an Electronic Flight Bag.

3. The system of claim 1, wherein at least some of the plurality of interactive data reference pages contain information comprising at least one of aircraft navigational data, aircraft procedures checklists or aircraft operating manuals.

4. The system of claim 1, wherein the data communication network interface device comprises at least one of a cockpit-installed private local area network server or an antenna, and data communications connections comprising at least one of wired, wireless or optical connections between communicating elements.

5. The system of claim 1, wherein the data communication network interface comprises an aircraft antenna for communicating with a WiFi server when within a communication area covered by the WiFi server in an airport.

6. The system of claim 1, wherein the at least one software application is a Voice-over-IP software application.

7. The system of claim 1, wherein data regarding at least one remote receiving node can be stored in the portable electronic data storage and display device for later recall.

8. The system of claim 1, wherein the user interface is integral to the data display unit and allows for touch manipulation of the at least one software application.

9. The system of claim 8, wherein the user interface that is integral to the data display unit provides access to information regarding at least one stored remote receiving node in order to facilitate one-touch call initiation to the at least one stored remote receiving node.

10. The system of claim 8, wherein the user interface that is integral to the data display unit includes at least an alpha-numeric touch pad usable to initiate a direct-dial call to at least one non-stored remote receiving node.

11. The system of claim 1, wherein the data display unit automatically displays information associated with a call to at least one remote receiving node while the call is in progress.

12. The system of claim 1, wherein the data input/output interface is usable to at least one of automatically receive calls or automatically initiate the at least one software application in response to an incoming call.

13. The system of claim 1, further comprising at least one of speakers or a microphone connected to the audio input/output interface.

14. The system of claim 11, wherein the at least one of speakers or a microphone is an integral headset including earphones and a microphone.

15. A method for facilitating voice communications and control, comprising:
initiating at least one software application for converting input audio signals to output data and input data to output audio signals by manipulating a user interface of a portable electronic data storage and display device that stores a plurality of interactive data reference pages and the at least one software application, and has the capability to receive audio inputs from and transmit audio inputs to a user;
at least one of placing a call to or receiving a call from at least one remote receiving node via a data communication network interface device with which the portable electronic data storage and display device is communicating through manipulation of the at least one software program via the user interface of the portable electronic data storage and display device,
wherein the at least one software application supports voice communications to the at least one remote receiving node via the data communication network interface device.

16. The method of claim 15, wherein the portable electronic data storage and display device is an Electronic Flight Bag.

17. The method of claim 15, wherein at least some of the plurality of interactive data reference pages contain information comprising at least one of aircraft navigational data, aircraft procedures checklists or aircraft operating manuals.

18. The method of claim 15, wherein the data communication network interface device comprises at least one of a cockpit-installed private local area network server or an antenna, and data communications connections comprising at least one of wired, wireless or optical connections between communicating elements.

19. The method of claim 15, wherein the data communication network interface comprises an aircraft antenna for communicating with a WiFi server when within a communication area covered by the WiFi server in an airport.

20. The method of claim 15, wherein the at least one software application is a Voice-over-IP software application.

21. The method of claim 15, wherein a user interface is integral to a data display unit in the portable electronic data storage and display device and the user interface allows for touch manipulation of the at least one software application.

22. The method of claim 21, further comprising storing data regarding at least one remote receiving node in the portable electronic data storage and display device for later recall.

23. The method of claim 22, wherein placing a call to at least one remote receiving node further comprises manipulating the user interface to recall data regarding at least one remote receiving node in order to facilitate one-touch call initiation to the at least one stored remote receiving node.

24. The method of claim 21, wherein placing a call to at least one remote receiving node further comprises manipulating the user interface to display at least an alpha-numeric touch pad usable to initiate a direct-dial call to at least one non-stored remote receiving node.

25. The method of claim 15, further comprising automatically displaying, on a data display unit of the portable electronic data storage and display device information associated with a call to at least one remote receiving node while the call is in progress.

26. The method of claim 15, wherein the data input/output interface is usable to at least one of automatically receive calls or automatically initiate the at least one software application in response to an incoming call.

27. A storage medium on which is recorded a program for implementing the method of claim 15.
